(19) United States
(12) Patent Application Publication
(10) Pub. No.: US 2016/0017991 A1
(43) Pub. Date: Jan. 21, 2016

(54) HYDRAULIC VALVE

(71) Applicant: Hilite Germany GmbH, Marktheidenfeld (DE)

(72) Inventors: Drazen Boban, Nuertingen (DE); Andreas Knecht, Kusterdingen (DE); Dieter Maisch, Kohlberg (DE)

(21) Appl. No.: 14/721,226

(22) Filed: May 26, 2015

(30) Foreign Application Priority Data
Jun. 27, 2014 (DE) DE102014109097.7

(51) Int. Cl. F16H 61/30; F16K 31/06; F16K 11/065

(52) U.S. Cl. CPC F16H 61/30; F16K 11/0655; F16K 31/0617; F16H 2061/307

(57) ABSTRACT

A hydraulic valve with at least two switching positions including a valve housing including a borehole which includes sections with different diameters along its longitudinal direction; a supply connection for supplying a hydraulic fluid; at least one first operating connection and a second operating connection; at least one first tank drain and a second tank drain for draining the hydraulic fluid; and a piston arranged in the borehole in the longitudinal direction of the borehole wherein the piston is supported at the valve housing at one end by a spring which imparts a spring force and wherein the piston is coupled longitudinally movable with a magnetic actuator which is provided for imparting a magnetic force, wherein a first control groove connects the first operating connection with the first tank drain or with the supply connection.

### RELATED APPLICATIONS

This application claims priority from and incorporates by reference German Patent Application DE 10 2014 109 097.7 filed on Jun. 27, 2014.

### FIELD OF THE INVENTION

The invention relates to a hydraulic valve, in particular for a dual clutch transmission of a motor vehicle.

### BACKGROUND OF THE INVENTION

A hydraulic valve with a valve housing is known from DE 10 2010 023 667 A1. A borehole with shoulders is configured in a valve housing wherein a wall of the borehole is micro-finished. A piston with shoulders is movably supported in the borehole with shoulders. Two connections are configured in the valve housing wherein the connections open into the borehole with shoulders in a radial direction and are arranged with an axial offset from one another. A section of the piston with shoulders has a reduced outer diameter relative to the borehole with shoulders wherein the reduced outer diameter forms a control groove wherein two connections that are arranged axially adjacent to one another are closable from each other by the piston with shoulders as a function of an axial positioning of the piston with shoulders and/or are connectable with each other through a portion with the reduced outer diameter.

In sliding valves of a transmission like in the hydraulic valve described in DE 10 2010 023 667 A there is a requirement in certain applications to use a piston with shoulders as a valve slide, wherein the piston with shoulders is movably supported in its variable positions. Therefore, a borehole forming a step with large diameter in the valve housing is provided with a micro-machined wall into which a bushing is pressed with its cylindrical enveloping surface, wherein the bushing extends over part of the length of the borehole, wherein an inner wall of the bushing is micro-machined and an inner borehole of the bushing forms the step with the small diameter of the borehole with shoulders.

The press bushing is moved into its target position in the borehole of the valve housing using axial force loading. In order to connect the inner borehole of the small shoulder of the borehole with shoulders with connections provided in the valve housing, one or plural radially continuous recesses are configured in the wall of the bushing, wherein the radially continuous recesses radially overlap with their respectively associated connections of the valve housing when the bushing is inserted.

### BRIEF SUMMARY OF THE INVENTION

Thus, it is an object of the invention to provide a hydraulic valve, in particular for a dual clutch transmission which facilitates servicing plural operating connections in an effective, cost-effective and space saving manner with good control properties.

The object is achieved by a hydraulic valve with at least two switching positions including a valve housing including a borehole which includes a first section and a second section with different diameters arranged along a longitudinal direction of the bore hole; a supply connection for supplying a hydraulic fluid; at least one first operating connection and a second operating connection; at least one first tank drain and a second tank drain for draining the hydraulic fluid; and a piston arranged in the borehole in the longitudinal direction of the borehole wherein the piston is supported at the valve housing at one end by a spring which imparts a spring force and wherein the piston is coupled longitudinally movable with a magnetic actuator which is provided for imparting a magnetic force, wherein a first control groove connects the at least one first operating connection with the at least one first tank drain or with the supply connection, wherein a second control groove connects the second operating connection with the second tank drain or with the supply connection, wherein a pin is arranged in the piston so that the pin is movable in the longitudinal direction relative to the piston wherein the piston cooperates with the spring in at least one switching position and wherein the pin is provided with a hydraulic connection with the second control groove, wherein the first control groove is defined by first operating surfaces with different sizes and wherein a larger of the first operating surfaces is arranged in the first section of the bore hole with a greater diameter than the second section of the borehole and a smaller of the first operating surfaces is arranged in the second section of the bore hole with a smaller diameter than in the first section of the borehole and the second control groove is defined by second operating surfaces which are arranged in the second section of the borehole with the smaller diameter.

Advantageous embodiments and advantages of the invention can be derived from the dependent patent claims, the description and the drawing figure.

A hydraulic valve with at least two switching positions is proposed which includes a valve housing with a borehole which includes sections with different diameters along its longitudinal extension, furthermore the hydraulic valve includes a supply connection for providing a hydraulic fluid, at least one first operating connection and a second operating connection, at least one first tank drain and a second tank drain for draining the hydraulic fluid from the piston, and a piston arranged in the borehole in its longitudinal direction, wherein the piston is supported at the valve housing at one end by a spring which imparts a spring force and a magnetic actuator which is provided for imparting a magnetic force and which is coupled longitudinally movable with the piston.

Thus, a first control groove connects the first operating connection alternatively with the first tank drain or with the supply connection while a second control groove connects the second operating connection alternatively with the second tank drain or with the supply connection. Furthermore, the hydraulic valve includes a pin that is arranged so that it is movable in a longitudinal direction relative to the piston wherein the pin interacts with the spring in at least one switching position and wherein the pin is hydraulically connected with the second control groove. The first control groove is defined by first operating surfaces with different sizes. A larger operating surface of the first operating surfaces is arranged in a first section with a larger diameter and a smaller of the first operating surfaces is arranged in a second section with a smaller diameter than the first section. The second control groove is defined by second operating surfaces which are arranged in the section of the borehole with the smaller diameter.

A force upon the piston is thus proportional to a difference of the two operating surfaces in the first section of the piston. In order to implement control operations of the hydraulic valve, it is necessary to provide a respective opposite force which can be implemented with a pressure upon the difference of the operating surfaces. Thus, the difference yields an effectively operative surface. The size of the operating surfaces depends from system parameters like operating pressures of the hydraulic valve and the inserted spring. The spring can be for example a compression coil spring. The effect of the second operating surfaces is mutually canceling since they have identical diameters.

From an interaction of the magnetic force, the force of the spring and the respectively loaded operating surface, a force equilibrium is provided in the control positions and determines output pressure at the operating connections. Thus, an oil pressure at the operating connections can be provided as a function of the electrical current at the magnetic actuator. Thus, the pressure is proportional to the current.

The pin which is advantageously loaded with the hydraulic fluid at its face thus forms another effective operating surface which can act against the magnetic force.

The hydraulic valve can be a transmission hydraulic valve, in particular a hydraulic valve for a dual clutch transmission.

Particularly advantageously, the hydraulic valve facilitates pressure regulating two channels independently from one another.

A magnetic actuator is a very effective drive for a hydraulic valve. Thus, pressure reduction valves can be configured with proportional characteristics since the magnetic force is proportional to the applied electrical current.

In an advantageous embodiment, the hydraulic valve can have at least three switching positions, wherein in a first switching position, the first operating connection is loaded with the hydraulic fluid through the supply connection and the second operating connection is connected with the second tank drain, wherein the supply connection is closed by the piston in a second switching position and the two tank drains are closed or opened by the piston, wherein the second operating connection is loaded with the hydraulic fluid through the supply connection in a third switching position and the first operating connection is connected with the tank drain.

The first switching position, which is approached from a basic position of the hydraulic valve with the magnetic actuator without current, initially has maximum pressure of the hydraulic fluid in the first operating connection since the supply connection is open. When the electrical current is increased, the pressure in the first operating connection decreases until the supply connection is completely closed in the second operating position and on the other hand side the first operating connection to the tank drain is open so that the pressure in the first operating connection drops to zero. The pressure in the second operating connection is also zero since the second operating connection to the second tank drain is also open.

With increasing electrical current loading of the magnetic actuator, the spring is over pressurized and the supply connection in the third switching stage towards the second operating connection is opened further, the pressure of the hydraulic fluid in the second operating connection increases further until it reaches a maximum value which corresponds to the supply pressure of the hydraulic system which is typically 20 bar in transmissions.

In an advantageous embodiment, the piston can include control edges so that the supply connection and the two tank drains are closable when the piston is accordingly positioned in a control position in longitudinal direction, wherein a control edge of the piston at the supply connection and a control edge of the piston at the tank drain swing in opposite directions during control movements between an open position and a closed position in a first switching position and the control edge of the piston at the supply connection and the control edge of the piston at the tank drain swing in opposite directions during control movements between an open position and a closed position in a third switching position.

In a control position of the first switching position an inflow of the hydraulic fluid is initially opened by the control edge at the supply connection, whereas the control edge at the first tank drain is closed. With increasing pressure in the first operating connection and at the difference of the operating surfaces of the piston in the first section, the control edge at the supply connection increasingly closes the inflow of the hydraulic fluid and the control edge towards the first tank drain increasingly opens the drain of the hydraulic fluid. The pressure in the first operating connection drops off, the piston moves back, the control edge at the supply connection opens the inflow and the control edge at the tank drain closes the tank drain again. Thus, the control edges at the supply connection and at the tank drain swing back and forth and thus open and close both openings in an opposite sense relative to one another. For a given current loading of the magnetic actuator, a correlated hydraulic pressure in the first operating connection is established by the control through the control edges. The force upon the piston caused by the difference of the operating surfaces counteracts the spring force so that an equilibrium is established. The spring force is advantageously 10 N. Advantageously, a movement of the piston towards the first operating surfaces is controllable by a pressure of the hydraulic fluid on the first operating surfaces, wherein a control force is proportional to a size difference of the first operating surfaces.

A control position of the third switching position is established analogously. The piston performs a maximum stroke against the spring when the magnetic force of the magnetic actuator is greater than the spring force. The control edge at the supply connection opens the inflow of the hydraulic fluid towards the second operating connection. A pressure builds up in the second operating connection and at the operating surface of the pin. The pressure on the operating surface generates a force component which acts against the magnetic force. The piston is thus moved back against the magnetic force so that the control edge closes the supply connection again and opens the second operating connection towards the second tank drain. Thus, a pressure in the second operating connection decreases again and thus a pressure at the operating surface of the pin decreases as well. The piston is moved into the direction of the magnetic force again so that the control edge opens the supply connection again and the pressure increases again. Thus, the pressure of the hydraulic fluid in the second operating connection is controlled by the control edges of the piston. Thus the force of the spring and the force on the operating surface of the pin act against the magnetic force so that a force equilibrium in the control position is achieved. The spring force advantageously amounts to e.g. 11 N.

The hydraulic valve according to the invention configured as a pressure reduction valve has the advantage that two operating connections can be supplied with hydraulic fluid so that an independently controlled pressure buildup and pressure reduction in both operating connections is feasible with a single hydraulic valve and a single magnetic actuator. Additionally, the hydraulic valve can be configured so that a magnetic force impacting the piston and a pressure of the hydraulic fluid impacting the piston act in combination so that effective operations and a safe control of the hydraulic valve can be provided. Furthermore, a very compact configuration of hydraulic valves with two operating connections can be implemented. In a third switching position, the piston can be additionally supported at the valve housing by the pin loaded by the hydraulic fluid which implements the control properties of the hydraulic valve in this switching position.

Using a borehole with shoulders in combination with a piston with shoulders, and control grooves facilitates building up a pressure of the hydraulic fluid on a difference of the two operating surfaces of the first control groove, wherein the pressure generates a force which supports the magnetic force on the piston, wherein both forces act against a spring force which is reacted at the valve housing. The control force upon the difference of the two operating surfaces is a product of an effective surface defined by a difference of the two different diameters of the borehole and thus of the two operating surfaces and the pressure of the hydraulic fluid in the control groove.

In an advantageous embodiment, the pin can be loadable by the hydraulic fluid through a borehole connected with the second control groove at an axially arranged operating surface, wherein the pin is supported at the valve housing with an end oriented against the pressure loading. Thus, a hydraulic pressure can build up on the pin, wherein the hydraulic pressure builds up a force on the piston opposite to the magnetic force. The piston can thus be pushed back again, the supply connection is closed more and more, the pressure of the hydraulic fluid drops which closes the control loop.

Advantageously, the operating surface of the pin can be without pressure as long as the magnetic force is less than or equal to the spring force. In these switching positions, the second operating connection is without pressure so that the operating surface of the pin can not be loaded with a pressure from the hydraulic fluid through the second operating connection.

Advantageously the hydraulic connection between the pin with the second control groove can be pressure loaded as long as the magnetic force is greater than the spring force, wherein a control force of the pin is proportional to a size of an operating surface of the pin. When the magnetic force is greater than the control force, the second operating connection to the supply connection is opened, thus the pressure in the second operating connection increases. Thus, also the operating surface of the pin is loaded with the pressure of the hydraulic fluid.

In an advantageous embodiment, the borehole can have a radially extending shoulder when transitioning from a first section to a second section, wherein the shoulder is arranged in longitudinal direction between the supply connection and the first operating connection. Thus, the two operating surfaces defining the first control groove have different surfaces so that the hydraulic fluid in the control groove imparts an effective force upon the effective differential surface of the two operating surfaces which is performed for example in a direction towards the first operating surface when the first operating surface is arranged in the section of the borehole with the larger diameter and the second operating surface is arranged in the section of the borehole with the smaller diameter.

Advantageously the supply connection, the two operating connections and the two tank drains can be configured as radial boreholes in the valve housing which extend from an outside of the valve housing to the borehole. Thus unimpeded inflow and outflow of the hydraulic fluid to and from the control grooves of the piston is provided. Also the connections to control components of the transmission in which the hydraulic fluid is used can be configured and sealed this way in a safe manner.

Advantageously, the hydraulic valve can be configured as a proportional pressure reducer valve, wherein a control force can be imparted upon the piston in that the piston receives a force in longitudinal direction from the magnetic actuator and a force equilibrium in the respective control position can be generated between the spring and the operating surfaces loaded by the hydraulic fluid. In particular a control force upon the piston can be imparted in a first control position in that the piston receives a force in longitudinal direction from the magnetic actuator and the first operating surfaces of the first control groove that are loaded by the hydraulic fluid and wherein the piston is loadable with a force from the spring in opposite direction. In a second control position, the control force upon the piston can be imparted in that the piston receives a force in longitudinal direction from the magnetic actuator and is loaded by the spring with a force in opposite direction.

In a third control position, the control force upon the piston can be imparted in that the piston receives a force in longitudinal direction from the magnetic actuator and is loadable by the spring and by the operating surface of the pin that is loaded with the hydraulic fluid so that a force in opposite direction is imparted upon the piston.

A magnetic actuator is a very effective driver for a hydraulic valve. Thus, pressure reduction valves can be configured with proportional properties since the magnetic force is proportional to the applied current. In order to implement control operations, it is necessary to have a respective opposite force available which can be typically implemented with a spring for example a compression coil spring. The strength of the spring thus depends from the system parameters like pressures and strokes. In the hydraulic valve according to the invention an additional effective force parallel to the magnetic force is imparted upon the piston through the first operating surface and the pressure of the hydraulic fluid, and on the other side a force in opposite direction to the magnetic force, thus parallel to the spring force is imparted onto the piston by the pin. This causes a force equilibrium in the respective control position. Through the described arrangement it is advantageous for the control properties to make the spring stronger than usual.

While known pressure control valves with springs that are used to facilitate a defined position of the piston in switched off condition without electrical current employ spring forces of approximately 0.4 N with a spring constant of approximately 0.2 N/mm, the hydraulic valve according to the invention uses springs with spring forces of approximately 10 N and a spring constant of approximately 7 N/mm. Also a maximum piston stroke which is approximately 1.5 mm in typical hydraulic valves is much higher in the hydraulic valve according to the invention and amounts to approximately 2.5 mm.

### BRIEF DESCRIPTION OF THE DRAWINGS

Further advantages can be derived from the following description of the drawings. The drawings illustrate embodiments of the invention. The drawings, the description and the claims include numerous features in combination. A person skilled in the art will certainly also consider the features individually and will combine them to useful additional combinations.

FIG. 1 illustrates a sectional view of a hydraulic valve according to an embodiment of the invention in a first switching position;

FIG. 2 illustrates a sectional view of the hydraulic valve according to FIG. 1 in a second switching position;

FIG. 3 illustrates a sectional view of the hydraulic valve of FIG. 1 in a third switching position; and

FIG. 4 illustrates a typical pressure distribution of a hydraulic valve according to an embodiment of the invention.

### DETAILED DESCRIPTION OF THE INVENTION

In the figures identical or equivalent components are designated with identical reference numerals. The figures only illustrate embodiments and they do not limit the scope of the invention.

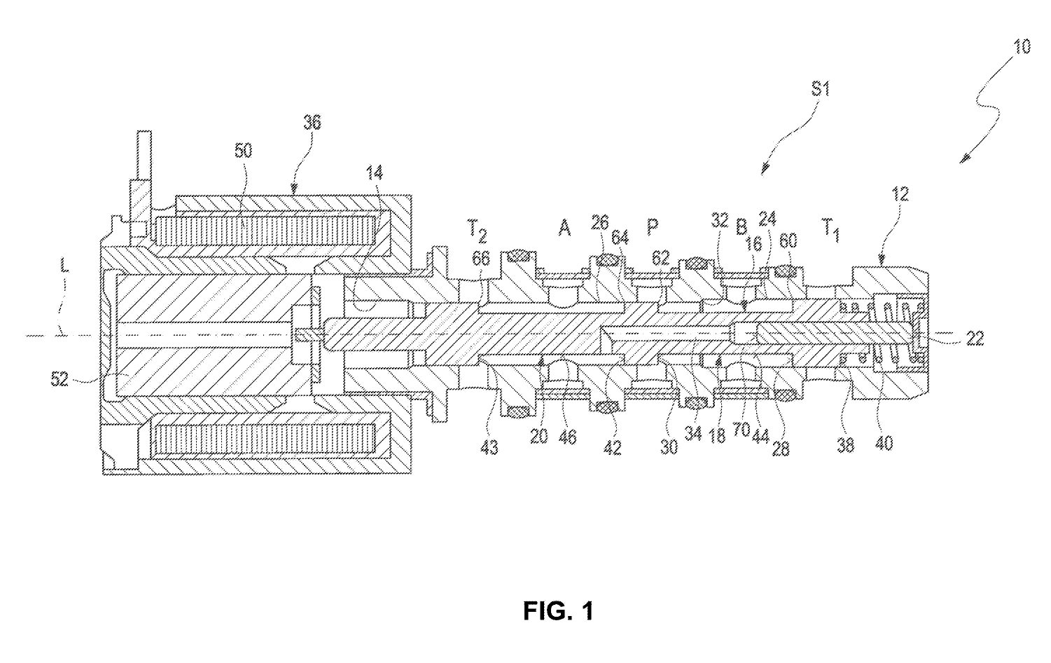

FIG. 1 illustrates a sectional view of a hydraulic valve 10 according to an embodiment of the invention in a first switching position S1. The hydraulic valve 10 with at least two switching positions S1, S2, S3 includes a valve housing 12 with a borehole 14 which includes sections 24, 26 along its longitudinal direction L which sections have different diameters, a supply connection P for feeding a hydraulic fluid, a first operating connection B and a second operating connection A, and a first tank drain T1 and a second tank drain T2 for draining the hydraulic fluid. Furthermore the hydraulic valve 10 includes a piston 16 arranged in a borehole 15 in its longitudinal direction L wherein the piston is supported at the valve housing 12 at one end 38 by a spring 40 which imparts a spring force and wherein the piston is coupled longitudinally movable with a magnetic actuator 36 which is provided for applying a magnetic force.

Thus a first control groove 18 connects the first operating connection B optionally with the first tank drain T1 or with the supply connection P and a second control groove 20 connected the second operating connection A optionally with the second tank drain T2 or with the supply connection P. Furthermore the hydraulic valve 10 includes a pin 22 that is arranged movable in the longitudinal direction L of the piston 16 relative to the piston 16, wherein the pin cooperates with the spring 40 in at least one switching position S1, S2, S3 and wherein the pin is hydraulically connected with the second control groove 20. Thus, the first control groove 18 is defined by first operating surfaces 28, 30 with different sizes. A larger one of the first operating surfaces 28 is arranged in a first section 24 with a larger diameter and a smaller one of the first operating surfaces 30 is arranged in a second section 26 with a smaller diameter than in the first section 24. The second control groove 20 is defined by second operating surfaces 42, 43 which are arranged in the section 26 of the borehole 14 with smaller diameter.

The hydraulic valve 10 has three switching positions S1, S2, S3 wherein the first operating connection B is loaded in the first switching position S1 with the hydraulic fluid through the supply connection P and the second operating connection A is connected with the second tank drain T2. In a second switching position S2, the supply connection P is closed by the piston 16. The two tank drains T1, T2 can be closed or opened by the piston 16 depending on the configuration of the hydraulic valve 10, whereas the second operating connection A is loaded in a third switching position S3 through the supply connection P with the hydraulic fluid and the first operating connection B is connected with the first tank drain T1.

The piston 16 has control edges 60, 62; 64, 66 so that depending on a positioning in a control position in the longitudinal direction L the supply connection P and the two tank drains T1, T2 are closable, wherein the control edge 62 of the piston 16 at the supply connection P and the control edge 60 of the piston 16 at the tank drain T1 swing in opposite directions with control movements between an open position and a closed position in the switching position S1 and the control edge 64 of the piston 16 at the supply connection P and the control edge 66 of the piston 16 at the tank drain T2 swing in opposite directions with control movements between an open position and a closed position in the switching position S3.

A movement of the piston 16 in a direction towards the first operating surface 28 is controllable through a pressure of the hydraulic fluid upon the first operating surfaces 28, 30, wherein an actuation force is proportional to a difference in size of the first operating surfaces 28, 30.

The pin 22 is loadable by the hydraulic fluid through a borehole 34 at an axially arranged operating surface 70 wherein the borehole 34 is connected with the second control groove 20 and the pin 22 is supported at the valve housing 12 with an end oriented against the pressure loading, wherein the operating surface 70 of the pin 22 is without pressure as long as the magnetic force is less than or equal to the spring force. The hydraulic connection of the pin 22 with the second control groove 20 is pressure loaded as long as the magnetic force is greater than the spring force.

A base surface 44 of the first control groove 18 has the same diameter over an entire length of the first control groove 18 like the base surface 46 of the second control groove 20. The borehole 14 has a radially extending step 32 when transitioning from the first section 24 to the second section 26, wherein the radially extending step is arranged in longitudinal direction L between the supply connection P and the first operating connection B. The supply connection P, the two operating connections B, A and the two tank drains T1, T2 are configured as radial boreholes in the valve housing 12 which radial boreholes reach from an outside of the valve housing 12 to the borehole 14.

The magnetic actuator 36 includes a coil 50 which generates a magnetic field when loaded with an electrical current, wherein the magnetic field drives an armature 52 and moves it in the longitudinal direction L. The armature 52 is in turn coupled with the piston 16 so that the piston 16 follows the movement of the armature 52.

Thus the hydraulic valve 10 is configured as a proportional pressure reduction valve, wherein a control force is impartible upon the piston 16 in that the piston 16 is provided by the magnetic actuator 36 with a force in longitudinal direction Land by a spring 40 which is advantageously configured as a compression coil spring and by the operating surfaces 28, 30, 70 that are loaded with the hydraulic fluid so that a force equilibrium is created in the respective control position S1, S2, S3. In particular the control force is imparted upon the piston 16 in the control position S1 in that the piston 16 is supplied with a force in longitudinal direction L through the magnetic actuator 36 and the first operating surfaces 28, 30 of the first control groove 18 and the piston is loaded with a force in opposite direction by the spring 40 and the loaded operating surface of the pin 22.

FIG. 1 illustrates the hydraulic valve 10 in the first switching position S1. Using the borehole 14 that is configured as a borehole with shoulders together with the piston 16 with shoulders and control grooves 18, 20 facilitates building up a pressure of the hydraulic fluid upon the difference of the first operating surface 28 and the second operating surface 30 of the first control groove 18 which causes a force supporting the magnetic force on the piston 16, wherein both forces act against a force of the spring 40 which is supported at the valve housing 12.

The control force on the first operating surface 28 therefore is a product of an effective surface which is defined by the difference of the two diameters in the two sections 24, 26 of the borehole 14 and thus of the operating surfaces 28, 30 and the pressure of the hydraulic fluid in the control groove 18. With increasing force, the supply connection P is closed more and more, the pressure of the hydraulic fluid drops, the force on the piston 16 thus also drops. The piston 16 is moved against the magnetic force again, the supply connection P opens and the pressure increases. Thus, the control loop is closed. This way, the pressure of the hydraulic fluid can be controlled by the control edges 60, 62 of the operating surfaces 28, 30 of the control groove 18.

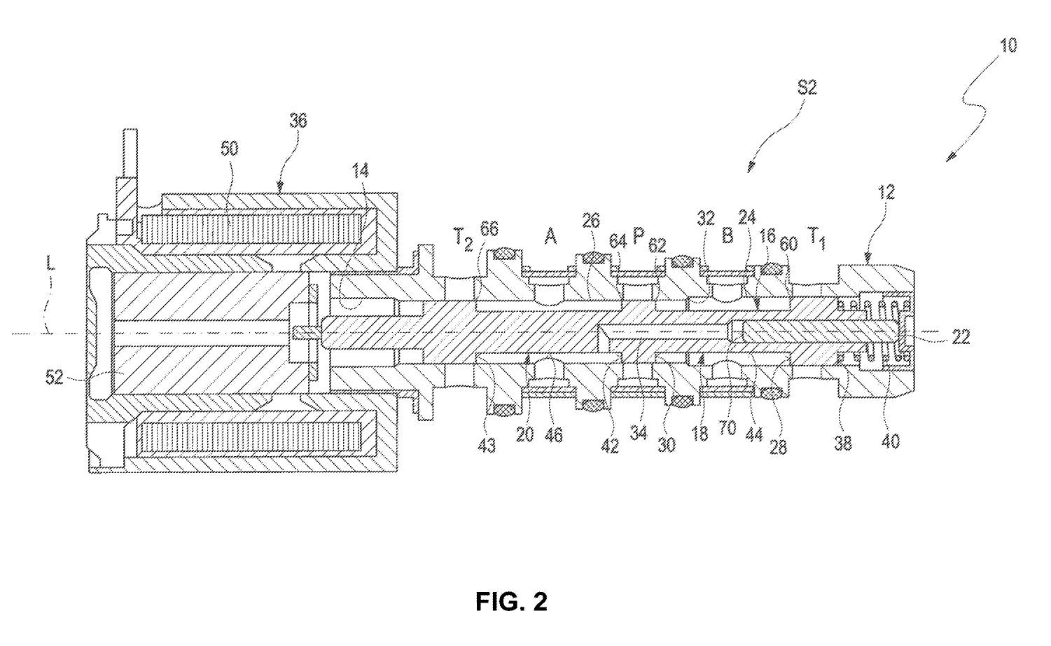

In comparison FIG. 2 illustrates a sectional view through the hydraulic valve 10 of FIG. 1 in a second switching position S2. The control force on the piston 16 is caused in the control position S2 in that the piston 16 absorbs a force in longitudinal direction L from the magnetic actuator 36 and is loadable a force in opposite direction from the spring 40. Thus, the piston 16 is moved further in longitudinal direction Land away from the magnetic actuator 36. With increase of the magnetic force on the piston 16 and thus a deflection of the piston 16 from its starting position the supply connection P is closed, the operating connections B, A are opened in a direction of the tank drains T1, T2 and thus the pressure in the operating connections B and A drops to zero and therefore also the difference of the operating surfaces 28, 30 does not impart any force upon the piston 16 anymore.

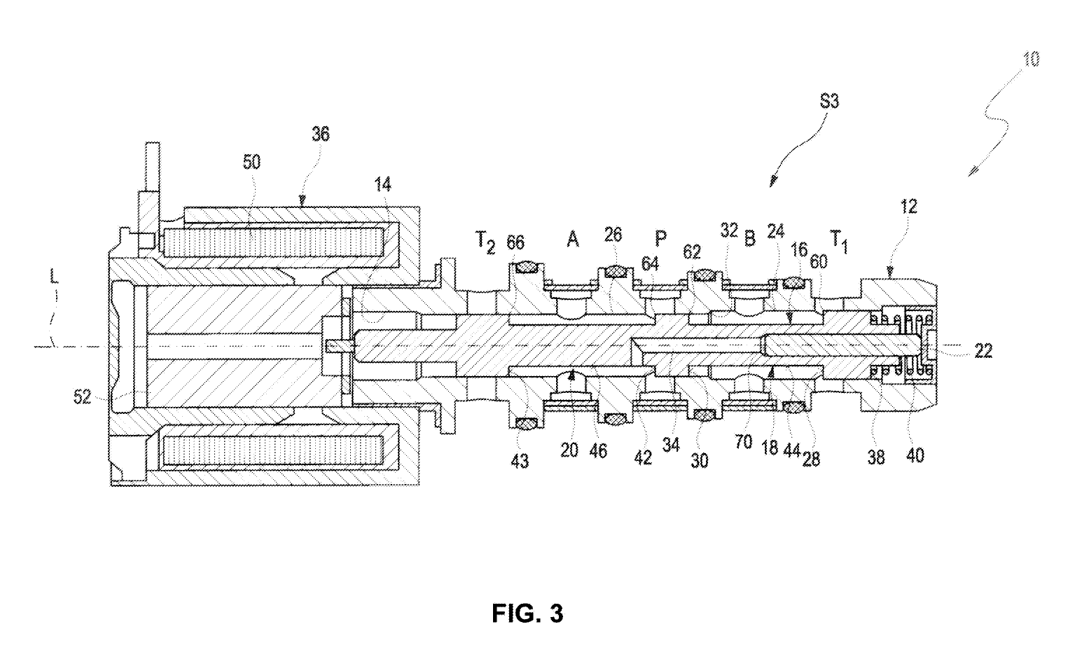

FIG. 3 illustrates a sectional view of the hydraulic valve 10 of FIG. 1 in a third switching position 83. The control force upon the piston 16 is imparted in the control position 83 in that the piston 16 receives a force in longitudinal direction L from the magnetic actuator 36 and is loadable with a force in opposite direction by the spring 40 and the operating surface 70 of the pin 22 that is loaded with the hydraulic fluid. The piston 16 is illustrated at its maximum deflection away from the magnetic actuator 36. An additional increase of the magnetic force on the piston 16 and thus an additional deflection of the piston 16 away from the basic position opens the supply connection P again in the direction of the second operating connection A; the pressure in the second control groove 20 which supplies the operating connection A increases which leads to an increase of the pressure in a borehole 34 which extends from the second control groove 20 and which supplies a face of the pin 22 that is movable in the longitudinal direction L of the piston 16, wherein the pin 22 is supported at the valve housing 12 with its other end. Thus, a hydraulic pressure can build up at the operating surface 70 of the pin 22 wherein the pin builds up a force on the piston 16 that is opposite to the magnetic force. The piston 16 is thus pushed back again, the supply connection P is closed more and more, the pressure of the hydraulic fluid drops which closes the control loop.

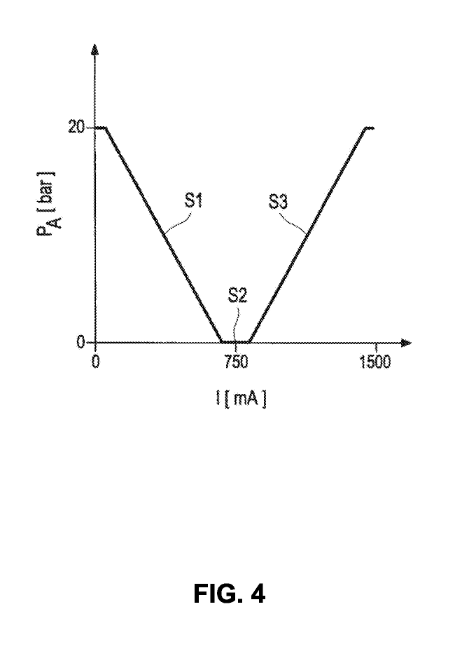

FIG. 4 illustrates a typical pressure diagram of a hydraulic valve 10 according to an embodiment of the invention. The diagram illustrates, a typical operating pressure P_{A} in one of the two operating connection B, A as a function of the switching position of the hydraulic valve 10 as a function of the electrical current I set at the magnetic actuator 36. In the switching position S1, P_{A} corresponds to the pressure in the first operating connection B. The pressure P_{A} decreases steeply with increasing electrical current loading of the magnetic actuator 36 from a maximum pressure of 20 bar until it is zero at a current of 750 ma. In this condition the switching position S2 is reached in which the supply connection P is closed and the two operating connections B, A to the tank drains T1, T2 are open. With increasing electrical current loading, the switching position S3 is reached in which the supply connection P to the second operating connection A is closed more and more so that the pressure Pa in the second operating connection A increases with increasing current loading of the magnetic actuator until it reaches a maximum value of 20 bar for a maximum electrical current loading of the magnetic actuator 36 of 1500 mA. The pressure range can thus be varied in a simple manner by adapting the operating surfaces 28, 30, 70.

What is claimed is:

1. A hydraulic valve with at least two switching positions, comprising;
a valve housing including a borehole which includes a first section and a second section with different diameters arranged along a longitudinal direction of the bore hole;
a supply connection for supplying a hydraulic fluid;
at least one first operating connection and a second operating connection;
at least one first tank drain and a second tank drain for draining the hydraulic fluid; and
a piston arranged in the borehole in the longitudinal direction of the borehole wherein the piston is supported at the valve housing at one end by a spring which imparts a spring force and wherein the piston is coupled longitudinally movable with a magnetic actuator which is provided for imparting a magnetic force,
wherein a first control groove connects the at least one first operating connection with the at least one first tank drain or with the supply connection,
wherein a second control groove connects the second operating connection with the second tank drain or with the supply connection,
wherein a pin is arranged in the piston so that the pin is movable in the longitudinal direction relative to the piston wherein the piston cooperates with the spring in at least one switching position and wherein the pin is provided with a hydraulic connection with the second control groove,
wherein the first control groove is defined by first operating surfaces with different sizes and wherein a larger of the first operating surfaces is arranged in the first section of the bore hole with a greater diameter than the second section of the borehole and a smaller of the first operating surfaces is arranged in the second section of the bore hole with a smaller diameter than in the first section of the borehole and the second control groove is defined by second operating surfaces which are arranged in the second section of the borehole with the smaller diameter.

2. The hydraulic valve according to claim 1,
wherein the hydraulic valve includes at least three switching positions, wherein
the first operating connection is loaded with the hydraulic fluid through the supply connection in a first switching position and the second operating connection is connected with the second tank drain,
wherein the supply connection is closed by the piston in a second switching position and the at least one first tank drain and the second tank drain are closed or opened by the piston, and
wherein the second operating connection is loaded with the hydraulic fluid through the supply connection in a third switching position and the first operating connection is connected with the at least one first tank drain.

3. The hydraulic valve according to claim 1,
wherein the piston includes control edges so that the supply connection and the first tank drain and the second tank drain are closable in a respective control position of the piston in the longitudinal direction,
wherein a control edge of the piston at the supply connection and a control edge of the piston at the at least one first tank drain swing in opposite directions performing control movements between an open position and a closed position in a first switching position, and
wherein a control edge of the piston at the supply connection and a control edge of the piston at the second tank drain swing in opposite directions performing control movements between an open position and a closed position in a third switching position.

4. The hydraulic valve according to claim 1, wherein a movement of the piston in a direction of the first operating surface is controllable by a pressure of the hydraulic fluid at the first operating surfaces.

5. The hydraulic valve according to claim 4, wherein a control force is proportional to a size difference of the first operating surfaces.

6. The hydraulic valve according to claim 1,
wherein the pin is loadable at an axially arranged operating surface with the hydraulic fluid through a second borehole that is connected with the second control groove, and
wherein the pin is supported at the valve housing with an end that is oriented opposite to the pressure loading.

7. The hydraulic valve according to claim 1, wherein an operating surface of the pin is without pressure as long as the magnetic force is less than or equal to the spring force.

8. The hydraulic valve according to claim 1, wherein the hydraulic connection of the pin with the second control groove is pressure loaded as long as the magnetic force is greater than the spring force.

9. The hydraulic valve according to claim 1, wherein a control force of the pin is proportional to a size of an operating surface of the pin.

10. The hydraulic valve according to claim 1, wherein the borehole transitioning from the first section to the second section has a radially extending step which is arranged in the longitudinal direction between the supply connection and the at least one first operating connection.

11. The hydraulic valve according to claim 1, wherein the supply connection, the at least one first operating connection, the second operating connection, the at least one first tank drain and the second tank drain are configured as radial boreholes in the valve housing which reach from an outside of the valve housing to the borehole.

12. The hydraulic valve according to claim 1,
wherein the hydraulic valve is configured as a proportional pressure reduction valve,
wherein a control force is impartible upon the piston in that the piston receives a force in the longitudinal direction from the magnetic actuator and a force equilibrium is generateable in a respective control position by the spring and the operating surfaces that are loaded by the hydraulic fluid.

13. The hydraulic valve according to claim 12,
wherein the control force is impartible upon the piston in the control position in that the piston receives a force in the longitudinal direction from the magnetic actuator and from the first operating surfaces of the first control groove which first operating surfaces are loaded by the hydraulic fluid, and
wherein the piston is loadable by the spring with a force in opposite direction to the force in the longitudinal direction.

14. The hydraulic valve according to claim 12, wherein the control force is impartible to the piston in the control position in that the piston receives a force in longitudinal direction from the magnetic actuator and a force in opposite direction to the force in the longitudinal direction is impartible to the piston by the spring.

15. The hydraulic valve according to claim 12,
wherein the control force is impartible to the piston in the control position in that the piston receives a force in the longitudinal direction from the magnetic actuator, and
wherein the piston is loadable with a force in the opposite direction to the force in the longitudinal direction by the spring and by the operating surface of the pin that is loaded by the hydraulic fluid.
